(19) United States
(12) Patent Application Publication
(10) Pub. No.: US 2010/0242481 A1
(43) Pub. Date: Sep. 30, 2010

(54) DRIVE APPARATUS, AND DRIVE-FORCE OUTPUT SYSTEM HAVING DRIVE APPARATUS, AND METHOD FOR CONTROLLING THE DRIVE APPARATUS

(75) Inventors: Sumikazu Shamoto, Nagoya-shi (JP); Tadayoshi Kachi, Obu-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/746,014

(22) PCT Filed: Dec. 3, 2008
(86) PCT No.: PCT/IB2008/003305

§ 371 Date: Jun. 3, 2010

(30) Foreign Application Priority Data
Dec. 4, 2007 (JP) 2007-313632

(51) Int. Cl. B60K 6/20; H02P 4/00

(52) U.S. Cl. 60/698; 318/139; 180/65.22

(57) ABSTRACT

A drive apparatus has: a DC power source that is chargeable and dischargeable; an electric motor that inputs and outputs drive force; an inverter circuit that drives the electric motor; a voltage-boosting circuit that boosts the voltage of power supplied from the DC power source and then supplies the power to the inverter circuit that is opposite from where the DC power source is present; and an auxiliary that is connected to and is powered from the inverter circuit side.

### BACKGROUND OF THE INVENTION

1. Field of the Invention

The invention relates to a drive apparatus and a drive-force output system incorporating the same drive apparatus, and a method for controlling the drive apparatus.

2. Description of the Related Art

Japanese Patent Application Publication No. 2006-262638 (JP-A-2006-262638) describes a drive apparatus in which the power supplied from a battery is boosted at a voltage-boosting DC-DC converter and then supplied to an inverter circuit for driving a motor and a generator. In this drive apparatus, an air-conditioner is connected to the low voltage side of the voltage-boosting DC-DC converter (the side where the output terminals of the battery are present).

According to this drive apparatus, however, a drive circuit incorporating power semiconductors having large current capacities needs to be used to sufficiently power the auxiliaries. When a voltage-boosting DC-DC converter having a large voltage-boosting capacity is used, the voltage of the battery is normally set to a low level and therefore current tends to be relatively large to sufficiently power the auxiliaries. In this case, therefore, power semiconductors having large current capacities need to be used in the drive circuit for driving the auxiliaries. Normally, the larger the current capacity of a power semiconductor is, the larger the size of the power semiconductor is, and such larger components increase the size of the drive circuit and its cost. Further, larger current causes larger loss, resulting in a less energy efficiency.

### SUMMARY OF THE INVENTION

The invention relates to a drive apparatus that enables downsizing power semiconductors used in a drive circuit for driving auxiliaries and provides a higher energy efficiency. The invention also relates to a drive-force output system incorporating such a drive apparatus, and a method for controlling the drive apparatus

The first aspect of the invention relates to a drive apparatus having: a DC power source that is chargeable and dischargeable; an electric motor that inputs and outputs drive force; an inverter circuit that drives the electric motor; a voltage-boosting circuit that boosts the voltage of power supplied from the DC power source and then supplies the power to the inverter circuit side of the voltage-boosting circuit that is opposite from where the DC power source is present; and an auxiliary that is connected to and is powered from the inverter circuit side of the voltage-boosting circuit.

According to the drive apparatus of the first aspect of the invention, the auxiliary is connected to the inverter circuit side of the voltage-boosting circuit that boosts the voltage of the power from the DC power source and then supplies it to the inverter circuit, that is, the side of the voltage-boosting circuit that is opposite from where the DC power source is present. Therefore, power at the high-voltage side is supplied to 15, the auxiliary, and this reduces the current supplied to the drive circuit for driving the auxiliary. As such, the above-described structure allows the use of power semiconductors having relatively low current capacities in the drive circuit for driving the auxiliary, and the relatively small size of such power semiconductors reduces the size of the drive circuit accordingly, and the energy efficiency of the drive apparatus improves.

The drive apparatus described above may further have a capacitor that is connected to a positive terminal of the DC power source and to a high-voltage side positive terminal of the voltage-boosting circuit. This structure suppresses the change in the voltage at the high-voltage side upon an abrupt change of the drive state of the electric motor and thus stabilizes the voltage.

The drive apparatus described above may further have a relay that is operable to connect the voltage-boosting circuit to and disconnect the voltage-boosting circuit from the DC power source; and a positive electric potential detector that detects the electric potential at a terminal of the capacitor that is connected to the high-voltage side positive terminal of the voltage-boosting circuit; and a system-shutdown controller that, if the relay is off when a command for shutting down a system incorporating the drive apparatus is issued, controls the inverter circuit so as to cause power to be consumed by the electric motor until the electric potential detected by the positive electric potential detector becomes substantially zero and that, if the relay is on when a command for &hutting down the system is issued, controls the inverter circuit so as to cause power to be consumed by the electric motor until the electric potential detected by the positive electric potential detector becomes substantially equal to the electric potential at the positive terminal of the DC power source. This structure enables releasing the electric charge accumulated in the capacity upon system shutdown regardless of whether the relay is on or off.

In this case, further, the system shutdown controller may accomplish the power consumption at the electric motor by controlling the inverter circuit so as to supply d-axis current to the electric motor. In this manner, the electric charge accumulated in the capacitor can be released without causing torque output from the electric motor.

The second aspect of the invention relates to a drive-force output system that outputs drive force to a drive shaft. This drive-force output system incorporates one of the drive apparatuses described above which at least has: a DC power source that is chargeable and dischargeable; an electric motor that inputs and outputs drive force; an inverter circuit that drives the electric motor; a voltage-boosting circuit that boosts the voltage of power supplied from the DC power source and then supplies the power to the inverter circuit side of the voltage-boosting circuit; and an auxiliary that is connected to and is powered from the inverter circuit side of the voltage-boosting circuit. This drive-force output system further has an internal combustion engine; a power generator that generates power using at least a portion of drive force output from the internal combustion engine; and a generator inverter circuit that is connected in parallel to the inverter circuit of the drive apparatus and drives the power generator. The electric motor of the drive apparatus is connected to the drive shaft and inputs drive force from and outputs drive force to the drive shaft.

Incorporating one of the above-described drive apparatuses, the drive-force output system of the second aspect of the invention provides the same effects and advantages as those obtained with the drive apparatuses of the first aspect of the invention. That is, for example, small power semiconductors can be used in the drive circuit for driving the auxiliary, and the energy efficiency of the drive apparatus improves, and the change in the voltage at the high-voltage side upon an abrupt change of the drive state of the electric motor can be suppressed and therefore the voltage can be stabilized.

The third aspect of the invention relates to a drive-force output system that outputs drive force to a drive shaft. This drive-force output system incorporates one of the drive apparatuses described above which at least has: a DC power source that is chargeable and dischargeable; an electric motor that inputs and outputs drive force; an inverter circuit that drives the electric motor; a voltage-boosting circuit that boosts the voltage of power supplied from the DC power source and then supplies the power to the inverter circuit; and an auxiliary that is connected to and is powered from the inverter circuit side of the voltage-boosting circuit. This drive-force output system also has an internal combustion engine; a drive-shaft-side electric motor that inputs drive force from and outputs drive force to the drive shaft; and a drive-shaft-side inverter circuit that is connected in parallel to the inverter circuit of the drive apparatus and drives the drive-shaft side electric motor. The electric motor, of the drive apparatus is connected to an output shaft of the internal combustion engine and generates power using at least a portion of drive force output from the internal combustion engine.

Incorporating one of the above-described drive apparatuses, the drive-force output system of the third aspect of the invention provides the same effects and advantages as those obtained with the drive apparatuses of the first aspect of the invention. That is, for example, small power semiconductors can be used in the drive circuit for driving the auxiliary, and the energy efficiency of the drive apparatus improves, and the change in the voltage at the high-voltage side upon an abrupt change of the drive state of the electric motor can be suppressed and therefore the voltage can be stabilized.

The fourth aspect of the invention relates to a method for controlling a drive apparatus having a DC power source that is chargeable and dischargeable; an electric motor that inputs and outputs drive force; an inverter circuit that drives the electric motor; and a voltage-boosting circuit that is connected to between the DC power source and the inverter circuit. In this method, the voltage of power of the DC power source is boosted and the power is then supplied to an auxiliary that is connected to the inverter circuit side of the voltage-boosting circuit.

Further, this method may be such that: it is determined whether a system incorporating the drive apparatus is being shut down, if the system is being shut down, it is then determined whether a relay that is operable to connect the voltage-boosting circuit to and disconnect the voltage-boosting circuit from the DC power source is on or off, if the relay is determined to be off, a first electric potential representing the electric potential at a terminal of a capacitor that is connected to a high-voltage side positive terminal of the voltage-boosting circuit is detected and the inverter circuit is then controlled so as to cause power to be consumed by the electric motor until the detected first electric potential becomes substantially zero, and if the relay is determined to be on, the first electric potential and a second electric potential representing the electric potential at a positive terminal of the DC power source are detected and the inverter circuit is then controlled so as to cause power to be consumed by the electric motor until the first electric potential becomes substantially equal to the second electric potential.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a view schematically showing the configuration of a hybrid vehicle 20 incorporating a drive apparatus according to an example embodiment of the invention;

FIG. 2 is a view schematically showing the main portions of the electric system of the hybrid vehicle 20; and

FIG. 3 is a flowchart illustrating an example of a system-shutdown voltage control routine that a hybrid ECU executes at the time of system shutdown.

### DETAILED DESCRIPTION OF THE EMBODIMENTS

Hereinafter, an example embodiment of the invention will be described.

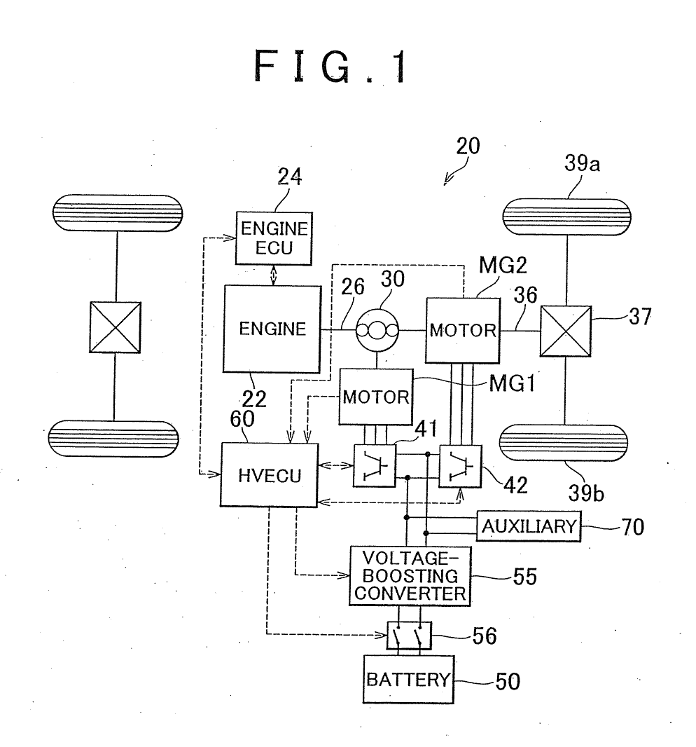

FIG. 1 is a view schematically showing the configuration of a hybrid vehicle 20 incorporating a drive apparatus according to an example embodiment of the invention. The hybrid vehicle 20 has an engine 22, an engine electronic control unit (will be referred to as “engine ECU”) 24, a planetary gear mechanism 30 the carrier of which is coupled with a crankshaft 26 of the engine 22 and the ring gear of which is coupled with a drive shaft 36 that is connected to drive wheels 39a, 39b via a differential 37, an electric motor MG1 connected to the sun gear of the planetary gear mechanism 30 and operable as a power generator, an electric motor MG2 that inputs drive force from and outputs drive force to the drive shaft 36 and is operable as a power generator, a battery 50, an inverter 41 serving as a drive circuit for the electric motor MG1, an inverter 42 serving as a drive circuit for the electric motor MG2, a voltage-boosting circuit 55 for voltage adjustment needed for power exchange with the battery 50, a system main relay 56 used to disconnect the battery 50 from the voltage-boosting circuit 55 when necessary, an auxiliary 70 connected to the high-voltage side of the voltage-boosting circuit 55 (the side where the inverters 41, 42 are present), and a hybrid electronic control unit (will be referred to as “hybrid ECU”) 60 that controls the overall operation of the hybrid vehicle 20.

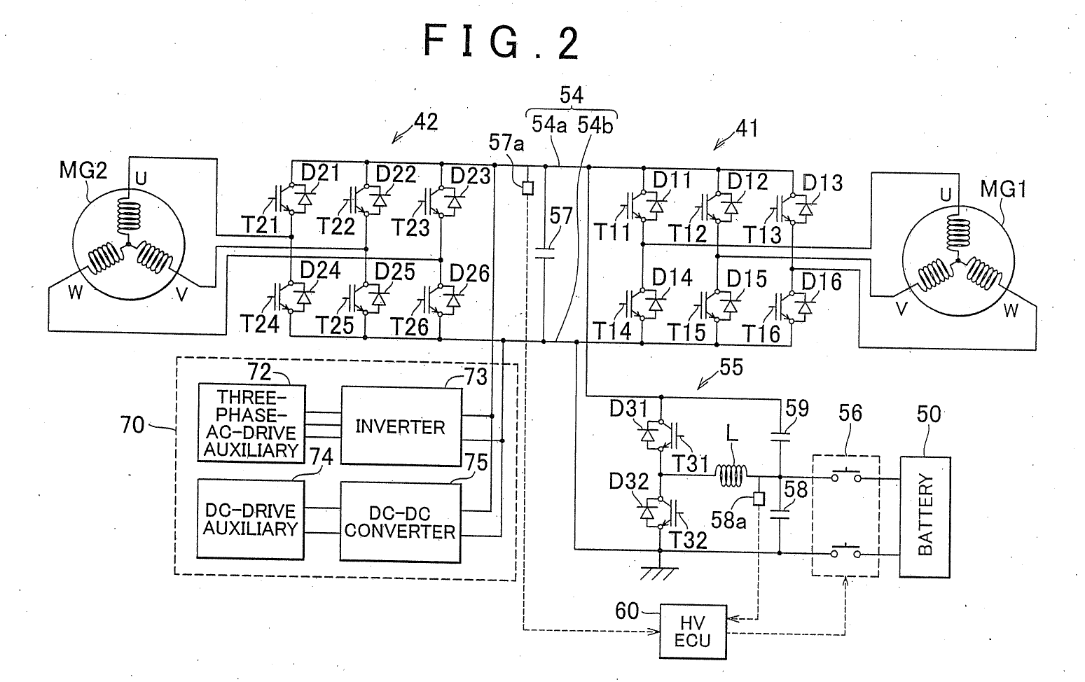

FIG. 2 schematically shows the main portions of the electric system of the hybrid vehicle 20. The electric motors MG1 and MG2 are both a known synchronous motor generator having a rotor on the outer face of which permanent magnets are attached and a stator around which a three-phase coil is wound. The inverter 41 has six transistors T11 to T16 and six diodes D11 to D16 connected in parallel to the respective transistors T11 to T16 in the opposite direction. The inverter 42 has six transistors T21 to T26 and six diodes D21 to D26 connected in parallel to the respective transistors T21 to T26 in the opposite directions. The transistors T11 to T16 and the transistors T21 to T26 are paired such that each pair is connected between a positive bus 54a and a negative bus 54b that are shared as a power line 54 by the inverters 41, 42. A source of one transistor in each pair is connected to a sink of another transistor. Thus, the transistors T11 to T16 and T21 to T26 are arranged such that the sources thereof are on the positive bus 54a side and sinks thereof are on the negative bus 54b side. The three coils of the three-phase coil (U-phase, V-phase, W-phase) of the electric motor MG1 and MG2 are connected to the respective connection points between transistors T11 to T16 and T21 to T26. As the ON-durations of each pair of the transistors T11 to T16 and T21 to T26 are controlled while a voltage is applied between the positive bus 54a and the negative bus 54b, rotational magnetic fields are created at the three-phase coils of the electric motors MG1, MG2, whereby each motor MG1, MG2 rotates. Because the inverters 41, 42 share the positive bus 54a and the negative bus 54b, the power generated at one of the motors MG1, MG2 can be supplied to the other. Note that a smoothing capacitor 57 is connected to the positive bus 54a and the negative bus 54b.

Referring to FIG. 2, the voltage-boosting circuit 55 is constituted of two transistors T31, T32, two diodes D31, D32 connected in parallel with the transistors T31, T32 in the opposite directions, and a reactor L. The two transistors T31, T32 are connected to the positive bus 54a and the negative bus 54b of the inventors 41, 42, respectively, and the reactor L is connected to the connection point between the transistors T31, T32. The positive terminal, and the negative terminal of the battery 50 are connected to the reactor L and to the negative bus 54b, respectively. The voltage of the DC power from the battery 50 is boosted through on-off control of the transistors T31, T32 and then supplied to the inverter 41, 42. On the other hand, the voltage of the DC power supplied to the positive bus 54a and the negative bus 54b is reduced through on-off control of the transistors T31, T32 and then charged to the battery 50. A smoothing capacitor 58 is connected to the reactor L and to the negative bus 54b. A voltage-boosting capacitor 59 is connected to the high-voltage-side positive terminal of the voltage-boosting circuit 55 (the positive bus 54a) and to the low-voltage-side positive terminal of the voltage-boosting circuit 55 (the terminal connected to the positive side of the battery 50). The voltage-boosting capacitor 59 suppresses voltage fluctuation at the positive bus 54a which may occur due to changes in the amount of power consumed by the electric motors MG1, MG2 and due to changes in the amount of power regenerated at the electric motors MG1, MG2. The capacity of the voltage-boosting capacitor 59 is determined based on the performance of each electric motor MG1, MG2.

Referring to FIG. 2, the auxiliary 70 includes, for example, a three-phase-AC-drive auxiliary 72 that operates on three-phase AC power that is obtained by boosting DC power at the voltage-boosting circuit 55 and then converting it at the inverter 73 and a DC-drive auxiliary 74 that operates on DC power the voltage of which has been boosted at the voltage-boosting circuit 55 and then regulated at the DC-DC converter 75. As such, because the auxiliary 70 is connected to the high-voltage side of the voltage-boosting circuit 55, power semiconductors having relatively low current capacities can be used in the inverter 73 and the DC-DC converter 75, and this contributes to downsizing the inverter 73 and the DC-DC converter 75 and reducing their costs.

Although not illustrated in the drawings, the hybrid ECU 60 is a microprocessor having a CPU (Central Processing Unit) as a main component, a ROM (Read Only Memory) storing various control and operation programs, a RAM (Random Access Memory) for temporarily storing various data, a timer for time count, an input port, an output port, and a communication port. Through the input port, the hybrid ECU 60 receives various signals including: the signals from an electric potential sensor 57a provided on the positive bus 54a to detect high-voltage side electric potential Vh; the signals from an electric potential sensor 58a connected to the low-voltage side positive terminal of the voltage-boosting circuit 55 to detect a low-voltage side electric potential V1; the signals from current sensors (not shown in the drawings) provided at the inverters 41, 42 to detect phase currents; the signals from rotational position sensors (not shown in the drawings) for detecting the rotational positions of the rotors of the electric motors MG1, MG2; the signals from an ignition switch (ignition signals) (not shown in the drawings); the signals from a shift position sensor for detecting the position of the shift lever; the signals from an accelerator-pedal position sensor for detecting the travel of the accelerator pedal; the signals from a brake-pedal position sensor for detecting the travel of the brake pedal; and the signals from a vehicle speed sensor for detecting a vehicle speed V, and so on. On the other hand, through the output port, the hybrid ECU 60 outputs various signals including: drive signals for the system main relay 56; switching signals for the switching elements of the voltage-boosting circuit 55; and switching signals for the switching elements of the inverters 41, 42, and so on. The hybrid ECU 60 is connected via the communication port to the engine ECU 24 and exchanges various control signals and various data with the engine ECU 24.

Having the foregoing structure, the hybrid vehicle 20 of this example embodiment of the invention calculates target torque required to be output to the drive shaft 36 based on the accelerator operation amount corresponding to the travel of the accelerator pedal depressed by the driver and the vehicle speed and controls the engine 22, the electric motors MG1, MG2 so as to output drive force corresponding to the target torque to the drive shaft 36. The engine 22 and the electric motors MG1, MG2 are operated in the following operation modes. The first mode is a torque conversion mode in which the engine 22 is controlled so as to output the target drive force while controlling the electric motors MG1, MG2 such that the drive force output from the engine 22 is entirely converted into torque via the planetary gear mechanism 30 and the electric motors MG1, MG2 and then output to the drive shaft 36. The second operation mode is a charge-discharge operation mode in which the engine 22 is controlled so as to output drive force corresponding to the sum of the target drive force and the drive force (electric power) necessary for charging or discharging of the battery 50 while controlling the electric motors MG1, MG2 such that, while charging or discharging of the battery 50, the drive force output from the engine 22 is entirely, or partially, converted into torque via the planetary gear mechanism 30 and the electric motors MG1, MG2 and then output to the drive shaft 36. The third mode is a motor drive mode in which the engine 22 is stopped and the electric motor MG2 is controlled so as to output the target drive force to the drive shaft 36.

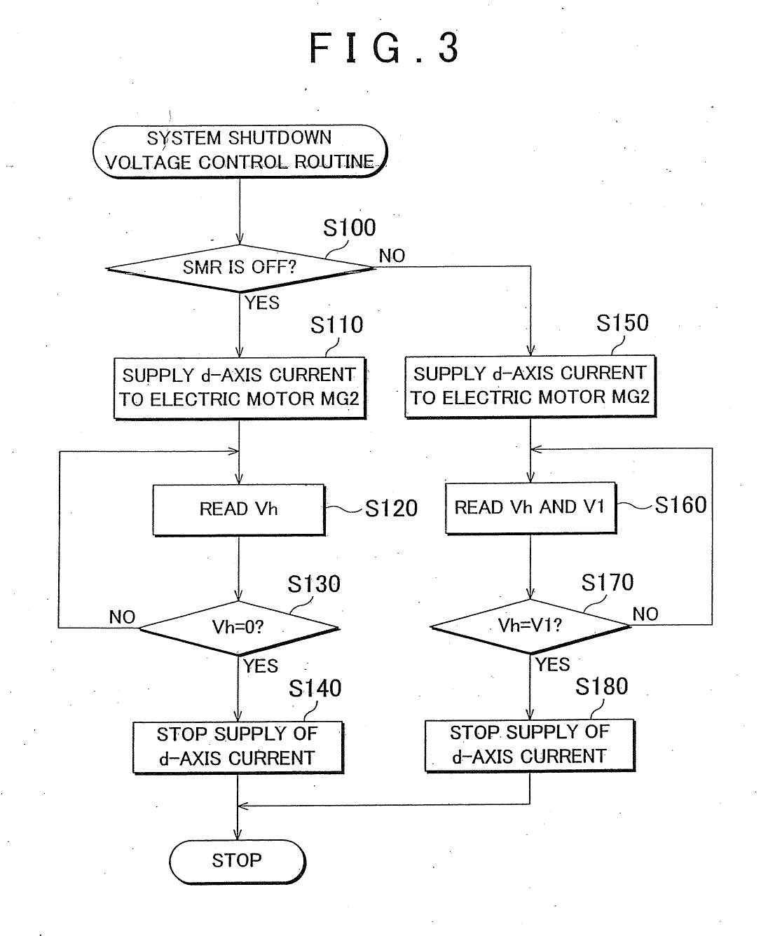

Next, the operation of the hybrid vehicle 20 configured as described above, in particular, the operation performed at the time of system shutdown (ignition off) will be described. For example, the system of the hybrid vehicle 20 is shut down when the engine ECU 24 detects that the engine 22 has been turned off. FIG. 3 is a flowchart illustrating an example of a system-shutdown voltage control routine that the hybrid ECU 60 executes at the time of system shutdown.

After the start of the-routine, the hybrid ECU 60 first determines whether the system main relay 56 is now on or off (step S100). This determination may be performed by, for example, referring to the value of a flag indicating the state of the system main relay 56.

At this time, if the system main relay 56 is off, the inverter 42 is controlled (switched) such that d-axis current is supplied to the three-phase coil of the electric motor MG2 (step S110), and then the control for supplying d-axis current to the three-phase coil of the electric motor MG2 is stopped (step S140) when the high-voltage side electric potential Vh detected by the electric potential sensor 57a provided on the positive bus 54a becomes zero (step S120 and step S130), after which the routine is finished. By thus supplying d-axis current to the three-phase coil of the electric motor MG2, power can be consumed as copper loss at the three-phase coil of the electric motor MG2 without causing rotational torque output from the rotor of the electric motor MG2. Through this control, the electric charges accumulated in the smoothing capacitor 57 and the voltage-boosting capacitor 59 are consumed, whereby the voltage between the terminals of the smoothing capacitor 57 and the voltage between the terminals of the voltage-boosting capacitor 59 become zero.

On the other hand, if it is determined in step S100 that the system main relay 56 is on, as in the above-described case where the system main relay 56 is off, d-axis current is supplied to the three-phase coil of the electric motor MG2 by controlling (switching) the inverter 42 (step S150), and then the control for supplying d-axis current to the three-phase coil of the electric motor MG2 is stopped (step S180) after the high-voltage side electric potential Vh detected by the electric potential sensor 57a provided on the positive bus 54a becomes equal to the low-voltage side electric potential V1 detected by the electric potential sensor 58a connected to the low-voltage side positive terminal of the voltage-boosting circuit 55 (step S160, step S170), after which the routine is finished. In this case, because the system main relay 56 is on, the low-voltage side electric potential V1 equals the electric potential at the positive terminal of the battery 50. Therefore, if the high-voltage side electric potential Vh is equal to the low-voltage side electric potential V1, it indicates that the electric potential at the positive terminal of the voltage-boosting capacitor 59 is equal to the electric potential at the positive terminal of the battery 50, and therefore the voltage between the terminals of the voltage-boosting capacitor 59 is zero. Through this control, the electric charge accumulated in voltage-boosting capacitor 59 can be consumed, whereby the voltage between the terminals of the voltage-boosting capacitor 59 becomes zero.

According to the hybrid vehicle 20 described above, because the auxiliary 70 is connected to the high-voltage side of the voltage-boosting circuit 55, power semiconductors having relatively low current capacities can be used in the inverter 73 and the DC-DC converter 75, and this contributes to downsizing the inverter 73 and the DC-DC converter 75 and reducing their costs. As such, the energy efficiency of the hybrid vehicle 20 is high.

According to the hybrid vehicle 20 of the foregoing example embodiment, further, because the voltage-boosting capacitor 59 is connected to the high-voltage side positive terminal of the voltage-boosting circuit 55 (the positive bus 54a) and to the low-voltage side positive terminal of the voltage-boosting circuit 55 (the terminal connected to the positive side of the battery 50), the voltage at the positive bus 54a does not largely change even when the amount of power consumed by each electric motor MG1, MG2 or the amount of power regenerated at each electric motor MG1, MG2 changes.

According to the hybrid vehicle 20 of the foregoing example embodiment, because d-axis current is supplied to the three-phase coil of the electric motor MG2 so as to zero the voltage between the terminals of the voltage-boosting capacitor 59 at the time of system shutdown, the electric charge accumulated in the voltage-boosting capacitor 59 can be consumed without causing torque output from the rotor of the electric motor MG2. According to the hybrid vehicle 20 of the foregoing example embodiment, further, in a case where the system main relay 56 is off at the time of system shutdown, when the high-voltage side electric potential Vh detected by the electric potential sensor 57a provided on the positive bus 54a has become zero, the voltage between the terminals of the voltage-boosting capacitor 59 is determined to have become zero and therefore the supply of d-axis current to the voltage-boosting capacitor 59 is stopped at this time. On the other hand, in a case where the system main relay 56 is on at the time of system shutdown, when the high-voltage side electric potential Vh detected by the electric potential sensor 57a provided on the positive bus 54a has become equal to the low-voltage side electric potential V1 detected by the electric potential sensor 58a connected to the low-voltage side positive terminal of the voltage-boosting circuit 55, the voltage between the terminals of the voltage-boosting capacitor 59 is determined to have become zero and therefore the supply of d-axis current to the three-phase coil of the electric motor MG2 is stopped at this time. In this manner, the voltage between the terminals of the voltage-boosting capacitor 59 can be made zero more reliably in accordance with the state of the system main relay 56.

While the electric charge accumulated in the voltage-boosting capacitor 59 is consumed by supplying d-axis current to the three-phase coil of the electric motor MG2 at the time of system shutdown in the hybrid vehicle 20 of the foregoing example embodiment, the electric charge accumulated in the voltage-boosting capacitor 59 may alternatively be consumed by supplying d-axis current to the three-phase coil of the electric motor MG1 or by supplying d-axis current to both the three-phase coil of the electric motor MG1 and the three-phase coil of the electric motor MG2, for example.

While the voltage-boosting capacitor 59 is connected to the high-voltage side positive terminal of the voltage-boosting circuit 55 (the positive bus 54a) and to the low-voltage side positive terminal of the voltage-boosting circuit 55 (the terminal connected to the positive side of the battery 50) in the hybrid vehicle 20 of the foregoing example embodiment, it is to be noted that the voltage-boosting capacitor 59 is not necessarily provided in the hybrid vehicle 20.

While the auxiliary 70 connected to the high-voltage side of the voltage-boosting circuit 55 has the three-phase-AC-drive auxiliary 72 that operates on three-phase AC power and the DC-drive auxiliary 74 that operates on DC power in the hybrid vehicle 20 of the foregoing example embodiment, the auxiliary 70 may alternatively have only an auxiliary that operates on three-phase AC power or only an auxiliary that operates on DC power.

While the invention has been embodied as the hybrid vehicle 20 in the foregoing example embodiment, the invention may alternatively be embodied as a drive-force output system having the engine 22, the electric motors MG1, MG2, the inverter 41, 42, the voltage-boosting circuit 55, the auxiliary 70, the system main relay 56, and the hybrid ECU 60, or the invention may alternatively be embodied as a drive apparatus having the electric motor MG2, the inverter 42, the voltage-boosting circuit 55, the auxiliary 70, the system main relay 56, and the hybrid ECU 60. Note that the drive-force output system and the drive apparatus are not necessarily provided in a vehicle.

In the foregoing example embodiment, the battery 50 may be regarded as an example of “DC power source” cited in the claims, the electric motor MG2 may be regarded as an example of “electric motor” cited in the claims, the inverter 42 may be regarded as “inverter circuit” cited in the claims, the voltage-boosting circuit 55 may be regarded as an example of “voltage-boosting circuit” cited in the claims, and the auxiliary 70 including the three-phase-AC-drive auxiliary 72 and the DC-drive auxiliary 74 may be regarded as an example of “auxiliary” cited in the claims. Further, the system main relay 56 may be regarded as an example of “relay” cited in the claims, the electric potential sensor 57a provided on the positive bus 54a may be regarded as an example of “positive electric potential detector” cited in the claims, and the hybrid ECU 60 that performs the system shutdown voltage control routine. As described above, in the system shut down voltage control routine, if the system main relay 56 is off at the time of system shutdown, controls the inverter 42 so as to supply d-axis current to the three-phase coil of the electric motor MG2 until the high-voltage side electric potential Vh detected by the electric potential sensor 57a provided on the positive bus 54a becomes zero and that, if the system main relay 56 is on at the time of system shutdown, controls the inverter 42 so as to supply d-axis current to the three-phase coil of the electric motor MG2 until the high-voltage side electric potential Vh detected by the electric potential sensor 57a provided on the positive bus 54a becomes equal to the low-voltage side electric potential V1 detected by the electric potential sensor 58a connected to the low-voltage side positive terminal of the voltage-boosting circuit 55 may be regarded as an example of “system-shutdown controller” cited in the claims.

The “DC power source” cited in the claims is not limited to the battery 50 but it may be any DC power source as long as it is chargeable and dischargeable. The “electric motor” cited in the claims is not limited to the electric motor MG2 but it may be any electric motor, including an induction motor, as long as it can input and output drive force. The “inverter circuit” cited in the claims is not limited to the inverter 42 constituted of the six transistors T21 to T26 and the six diodes D21 to D26 connected in parallel to the respective transistors T21 to T26 in the opposite directions, but it may alternatively be constituted of various other switching elements. The “voltage-boosting circuit” cited in the claims is not limited to the voltage-boosting circuit 55 constituted of the two transistors T31, T32, the two diodes D31, D32 connected in parallel to the respective transistors T31, T32 in the opposite directions, and the reactor L, but it may be any voltage-boosting circuit as long as it can boost the voltage of power supplied from the DC power source and then supply it to the inverter circuit side. The “auxiliary” cited in the claims is not limited to the auxiliary 70 including the three-phase-AC-drive auxiliary 72 and the DC-drive auxiliary 74 but it may be any auxiliary as long as it is connected to the inverter circuit side of the voltage-boosting circuit and is powered therefrom. The “relay” cited in the claims is not limited to the system main relay 56 but it may be any relay as long as it is operable to connect the voltage-boosting circuit to and disconnect it from the DC power source as needed. The “positive electric potential detector” cited in the claims is not limited to the electric potential sensor 57a provided on the positive bus 54a but it may be any detector as long as it detects the electric potential at the terminal of the capacitor that is connected to the high-voltage side positive terminal of the voltage-boosting circuit. The “system-shutdown controller” cited in the claims is not limited to the hybrid ECU 60 that executes the system-shutdown voltage control routine in which, if the system main relay 56 is off at the time of system shutdown, the inverter 42 is controlled so as to supply d-axis current to the three-phase coil of the electric motor MG2 until the high-voltage side electric potential Vh detected by the electric potential sensor 57a provided on the positive bus 54a becomes zero and, if the system main relay 56 is on at the time of system shutdown, the inverter 42 is controlled so as to supply d-axis current to the three-phase coil of the electric motor MG2 until the high-voltage side electric potential Vh detected by the electric potential sensor 57a provided on the positive bus 54a becomes equal to the low-voltage side electric potential V1 detected by the electric potential sensor 58a connected to the low-voltage side positive terminal of the voltage-boosting circuit 55. Alternatively, the “system-shutdown controller” cited in the claims may be, for example, a controller that, if the relay is off when a command for shutting down the system incorporating the drive apparatus is issued, controls the inverter circuit so as to consume the power at the electric motor until the electric potential detected by the positive electric potential detector becomes substantially zero and that, if the relay is on when a command for shutting down the system incorporating the drive apparatus is issued, controls the inverter circuit so as to consume the power at the electric motor until the electric potential detected by the positive electric potential detector becomes substantially equal to the electric potential at the positive terminal of the DC power source.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

The invention may be utilized in various industries for manufacturing drive apparatuses, drive-force output systems, and the like.

1. A drive apparatus, comprising:
a DC power source that is chargeable and dischargeable;
an electric motor that inputs and outputs drive force;
an inverter circuit that drives the electric motor;
a voltage-boosting circuit that boosts the voltage of power supplied from the DC power source and then supplies the power to the inverter circuit side of the voltage-boosting circuit that is opposite from where the DC power source is present;
an auxiliary that is connected to and is powered from the inverter circuit side of the voltage-boosting circuit;
a capacitor that is connected to a positive terminal of the DC power source and to a high-voltage side positive terminal of the voltage-boosting circuit;
a relay that is operable to connect the voltage-boosting circuit to and disconnect the voltage-boosting circuit from the DC power source;
a positive electric potential detector that detects the electric potential at a terminal of the capacitor that is connected to the high-voltage side positive terminal of the voltage-boosting circuit; and
a system-shutdown controller that, if the relay is off when a command for shutting down a system incorporating the drive apparatus is issued, controls the inverter circuit so as to cause power to be consumed by the electric motor until the electric potential detected by the positive electric potential detector becomes substantially zero and that, if the relay is on when a command for shutting down the system is issued, controls the inverter circuit so as to cause power to be consumed by the electric motor until the electric potential detected by the positive electric potential detector becomes substantially equal to the electric potential at the positive terminal of the DC power source.

2. (canceled)

3. (canceled)

4. The drive apparatus according to claim 1, wherein the system shutdown controller accomplishes the power consumption at the electric motor by controlling the inverter circuit so as to supply d-axis current to the electric motor.

5. The drive apparatus according to claim 1, further comprising a low-voltage side electric potential detector that is connected to a low-voltage side positive terminal of the voltage-boosting circuit and detects the electric potential at the positive terminal of the DC power source, wherein
the system shutdown controller determines whether the electric potential detected by the positive electric potential detector is substantially equal to the electric potential detected by the low-voltage side electric potential detector.

6. The drive apparatus according to claim 1, wherein the auxiliary has a drive circuit that drives the auxiliary and that incorporates a power semiconductor.

7. The drive apparatus according to claim 1, wherein the electric motor includes a first motor generator and a second motor generator, the inverter circuit includes a first inverter circuit for driving the first motor generator and a second inverter circuit for driving the second motor generator, and the first inverter circuit and the second inverter circuit share a positive bus and a negative bus together constituting a power line.

8. A drive-force output system that outputs drive force to a drive shaft, comprising:
the drive apparatus according to claim 1,
an internal combustion engine;
a power generator that generates power using at least a portion of drive force output from the internal combustion engine; and
a generator inverter circuit that is connected in parallel to the inverter circuit of the drive apparatus and drives the power generator; wherein
the electric motor of the drive apparatus is connected to the drive shaft and inputs drive force from and outputs drive force to the drive shaft.

9. A drive-force output system that outputs drive force to a drive shaft, comprising:
the drive apparatus according to claim 1;
an internal combustion engine;
a drive-shaft-side electric motor that inputs drive force from and outputs drive force to the drive shaft; and
a drive-shaft-side inverter circuit that is connected in parallel to the inverter circuit of the drive apparatus and drives the drive-shaft-side electric motor; wherein
the electric motor of the drive apparatus is connected to an output shaft of the internal combustion engine and generates power using at least a portion of drive force output from the internal combustion engine.

10. A method for controlling a drive apparatus having a DC power source that is chargeable and dischargeable; an electric motor that inputs and outputs drive force; an inverter circuit that drives the electric motor; and a voltage-boosting circuit that is connected to between the DC power source and the inverter circuit, wherein a capacitor is connected to a positive terminal of the DC power source and to a high-voltage side positive terminal of the voltage-boosting circuit; the method comprising:
boosting the voltage of power of the DC power source;
supplying the voltage-boosted power to an auxiliary that is connected to the inverter circuit side of the voltage-boosting circuit that is opposite from where the DC power source is present;
determining whether a system incorporating the drive apparatus is being shut down,
if the system is being shut down, determining whether a relay that is operable to connect the voltage-boosting circuit to and disconnect the voltage-boosting circuit from the DC power source is on or off,
if the relay is determined to be off, determining a first electric potential representing the electric potential at a terminal of a capacitor that is connected to a high-voltage side positive terminal of the voltage-boosting circuit and the inverter circuit is then controlled so as to cause power to be consumed by the electric motor until the detected first electric potential becomes substantially zero, and
if the relay is determined to be on, detecting the first electric potential and a second electric potential representing the electric potential at a positive terminal of the DC power source, and the inverter circuit is then controlled so as to cause power to be consumed by the electric motor until the first electric potential becomes substantially equal to the second electric potential.

11. (canceled)
